(19) United States
(12) Patent Application Publication
(10) Pub. No.: US 2023/0251545 A1
(43) Pub. Date: Aug. 10, 2023

(54) DISPLAY DEVICE

(71) Applicant: Japan Display Inc., Tokyo (JP)

(72) Inventor: Masataka IKEDA, Tokyo (JP)

(73) Assignee: Japan Display Inc., Tokyo (JP)

(21) Appl. No.: 18/166,501

(22) Filed: Feb. 9, 2023

(30) Foreign Application Priority Data
Feb. 10, 2022 (JP) 2022-019376

(51) Int. Cl. G02F 1/16756; G09G 3/34; G02F 1/167; G02F 1/16766; G02F 1/1362; G02F 1/1368

(52) U.S. Cl. CPC G02F 1/16756; G09G 3/344; G02F 1/167; G02F 1/16766; G02F 1/136286; G02F 1/1368; G09G 2310/0202; G09G 2300/0426; G09G 2300/0852; G02F 2202/28; G02F 1/13439

(57) ABSTRACT

According to one embodiment, a display device includes a first substrate including a plurality of pixel electrodes that include a plurality of first pixel electrodes and a plurality of second pixels, and an inorganic insulating layer that covers the plurality of pixel electrodes, a second substrate including a counter-substrate opposed to the plurality of pixel electrodes, and an electrophoretic layer arranged between the first substrate and the second substrate.

### CROSS-REFERENCE TO RELATED APPLICATIONS

This application is based upon and claims the benefit of priority from Japanese Patent Application No. 2022-019376, filed Feb. 10, 2022, the entire contents of which are incorporated herein by reference.

### FIELD

Embodiments described herein relate generally to a display device.

### BACKGROUND

As display devices, for example, electrophoretic display devices are known. An electrophoretic display device is equipped with an electrophoretic layer including capsules containing colored particles, electrodes and drive elements that drive the electrophoretic layer, and the like.

### BRIEF DESCRIPTION OF THE DRAWINGS

FIG. 1 is a circuit diagram showing a schematic example of a display device according to an embodiment.

FIG. 2 is a circuit diagram showing a pixel of the display device shown in FIG. 1.

FIG. 3 is a cross-sectional view showing an example of a schematic configuration of the display device of the embodiment.

FIG. 4 is a cross-sectional view showing a modified example of the schematic configuration shown in FIG. 3.

FIG. 5 is a cross-sectional view showing an example of a schematic configuration of a substrate.

FIG. 6 is a cross-sectional view showing a display device of a comparative example.

FIG. 7 is an enlarged plan view showing a part of a substrate of the embodiment.

FIG. 8 is an enlarged plan view showing a part of the substrate of the comparative example.

FIG. 9 is a view showing constituent elements formed of the same layer and the same material as a scanning line, of the display device shown in FIG. 7.

FIG. 10 is a view showing constituent elements formed of the same layer and the same material as a signal line, of the display device shown in FIG. 7.

FIG. 11 is a view showing constituent elements formed of the same layer and the same material as a scanning line, of the display device shown in FIG. 8.

FIG. 12 is a view showing constituent elements formed of the same layer and the same material as a signal line, of the display device shown in FIG. 8.

### DETAILED DESCRIPTION

In general, according to one embodiment, a display device comprises a first substrate including: a plurality of pixel electrodes that include a plurality of first pixel electrodes and a plurality of second pixels, and an inorganic insulating layer that covers the plurality of pixel electrodes; a second substrate including a counter-substrate opposed to the plurality of pixel electrodes; and an electrophoretic layer arranged between the first substrate and the second substrate.

Embodiments described herein aim to provide a display device capable of suppressing deterioration in display quality.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented, but such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

The embodiments described herein are not general embodiments, but embodiments in which the same or corresponding special technical features of the invention are described. A display device according to one of the embodiments will be described hereinafter with reference to the accompanying drawings.

In the embodiment, a first direction X, a second direction Y, and a third direction Z are orthogonal to each other, but may intersect at an angle other than 90 degrees. A direction toward a tip of an arrow indicating the third direction Z is referred to as an upper or upward direction, and a direction opposite to the direction toward the tip of the arrow indicating the third direction Z is referred to as a lower or downward direction. The first direction X, the second direction Y, and the third direction Z may be referred to as the X direction, the Y direction, and the Z direction, respectively.

In addition, expressions such as “a second member above a first member” and “a second member under a first member” mean that the second member may be in contact with the first member or may be located separately from the first member. In the latter case, a third member may be interposed between the first member and the second member. In contrast, according to “a second member above a first member” and “a second member under a first member”, the second member may be in contact with the first member.

In addition, an observation position at which the liquid crystal display device is to be observed is assumed to be located on the tip side of the arrow indicating the third direction Z, and viewing from the observation position toward an X-Y plane defined by the first direction X and the second direction Y is referred to as planar view. Viewing a cross-section of the liquid crystal display device on an X-Z plane defined by the first direction X and the third direction Z or a Y-Z plane defined by the second direction Y and the third direction Z is referred to as cross-sectional view.

### Embodiment 1

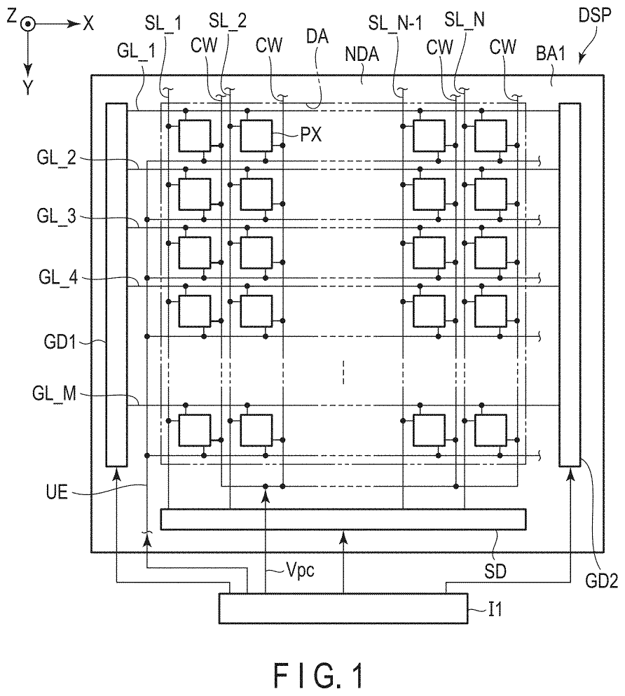

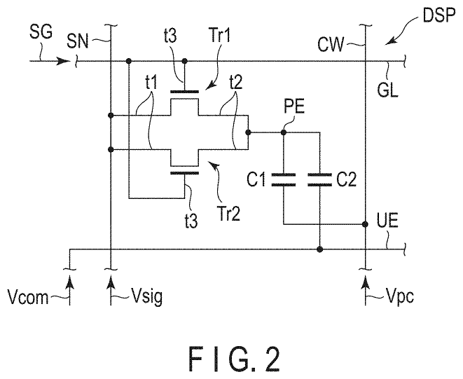

FIG. 1 is a circuit diagram showing a schematic example of the display device of the embodiment. FIG. 2 is a circuit diagram showing a pixel of the display device shown in FIG. 1. All pixels PX and all lines are not illustrated in FIG. 1 and FIG. 2.

The display device DSP includes a display area DA in which images are displayed and a non-display area NDA other than the display area DA. In the embodiments, the non-display portion NDA is formed in a picture frame shape.

As shown in FIG. 1, the display device DSP comprises a base material BA1, a plurality of pixels PX arrayed in a matrix, above the base material BA1 in the display area DA, a plurality of scanning lines GL, a plurality of signal lines SL, and a plurality of capacitive lines CW. The scanning lines and signal lines are also referred to as gate lines and source lines, respectively.

In the embodiment, the number of scanning lines GL is M, and the scanning lines are referred to as scanning lines GL_1 through GL_M, respectively. However, if the scanning lines do not need to be distinguished individually, the scanning lines are simply referred to as scanning lines GL. In addition, the number of signal lines SL is N, and the signal lines are referred to as signal lines SL_1 through SL_N, respectively. However, if the signal lines SL do not need to be distinguished individually, the signal lines are simply referred to as signal lines SL. In other words, the display device DSP includes pixels PX of M rows and N columns.

The display device DSP comprises scanning line drive circuits GD1 and GD2 (also referred to as gate drivers) and a signal line drive circuit SD (also referred to as a source driver). The scanning line drive circuits GD1 and GD2 drive the scanning lines GL to be described below. The scanning line drive circuits GD1 and GD2 are located in the non-display area NDA. The signal line drive circuit SD drives the signal lines SL. The signal line drive circuit SD is located in the non-display area NDA.

The scanning lines GL are connected to the scanning line drive circuit GD, extend in the first direction X, and are aligned in the second direction Y. The scanning lines GL are electrically connected to a plurality of pixels PX aligned in the first direction X. The signal lines SL are connected to the signal line drive circuit SD, extend in the second direction Y, and are aligned in the first direction X. The signal lines SL are electrically connected to a plurality of pixels PX aligned in the second direction Y. The capacitive lines CW extend in the first direction X or the second direction Y. In the embodiment, the capacitive lines CW extend in the second direction Y and are electrically connected to the plurality of pixels PX aligned in the second direction Y. The plurality of capacitive lines CW are bundled in the non-display area NDA and connected to an IC chip I1. The scanning line drive circuit GD supplies he control signal SG to the scanning lines GL and drives the scanning lines GL. The signal line drive circuit SD supplies an image signal (for example, a video signal) Vsig to the signal lines SL and drives the signal lines SL. The IC chip I1 supplies a constant voltage Vpc to the capacitive lines CW such that the capacitive lines CW are fixed to a constant potential. In addition, the IC chip I1 supplies a common voltage Vcom to a counter-electrode UE such that the counter-electrode UE is fixed to a constant potential (common potential). In the embodiment, the counter-electrode UE may be referred to as a common electrode since the counter-electrode CE is shared by all the pixels PX. In the embodiment, the capacitive lines CW are set to the same potential as the potential of the counter-electrode UE but may be set to a potential different from that of the counter-electrode UE. The scanning line drive circuits GD, the signal line drive circuit SD, and the IC chip I1 constitute a drive unit for driving the plurality of pixels PX.

As shown in FIG. 2, each of the pixels PX comprises a first transistor Tr1, a second transistor Tr2, a first capacitance C1, and a second capacitance C2. The first transistor Tr1 and the second transistor Tr2 are, for example, oxide semiconductor transistors in which semiconductor layers are oxide semiconductors.

Each of the first transistor Tr1 and the second transistor Tr2 includes a first terminal t1, a second terminal t2, and a control terminal t3. In the embodiment, the control terminal t3 functions as a gate electrode, either of the first terminal t1 and the second terminal t2 functions as a source electrode, and the other of the first terminal t1 and the second terminal t2 functions as a drain electrode. The first transistor Tr1 and the second transistor Tr2 are electrically connected parallel between the source line SL and the pixel electrode PE.

In each of the first transistor Tr1 and the second transistor Tr2, the first terminal t1 is connected to the signal line SL, the second terminal t2 is connected to the pixel electrode PE, and the control terminal t3 is connected to the scanning line GL. Each of the first transistor Tr1 and the second transistor Tr2 is thereby switched to a conductive state or a non-conductive state by the control signal SG supplied to the scanning line GL. The image signal Vsig is applied to the pixel electrode PE via the signal line SL, and the first transistor Tr1 and the second transistor Tr2 in the conducting state.

The first capacitance C1 and the second capacitance C2 are capacitors. The first capacitance C1 is connected between the pixel electrode PE and the capacitive line CW. The second capacitance C2 is connected between the pixel electrode PE and the counter-electrode UE.

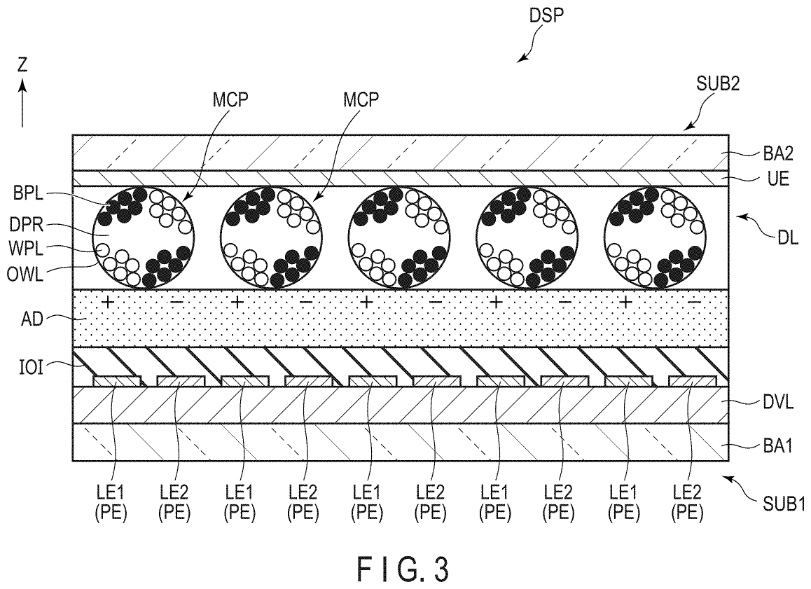

FIG. 3 is a cross-sectional view showing an example of a schematic configuration of the display device of the embodiment.

As shown in FIG. 3, the first substrate SUB1 comprises a base material BA1, a drive element layer DVL provided on the base material BA1, a plurality of pixel electrodes PE provided on the drive element layer DVL, and an inorganic insulating layer IOI covering the plurality of pixel electrodes PE. The plurality of pixel electrodes PE include a plurality of first pixel electrodes LE1 and a plurality of second pixel electrodes LE2. The first pixel electrodes LE1 and the second pixel electrodes LE2 are formed of the same material.

The drive element layer DVL includes the first transistor Tr1, the second transistor Tr2, the scanning lines GL, the signal lines SL, each wiring layer, each insulating layer, and the like described above.

The second substrate SUB2 comprises a base material BA2 opposed to the pixel electrodes PE, and a counter-electrode UE located between the base material BA2 and the pixel electrodes PE and opposed to the pixel electrodes PE. Each of the pixel electrodes PE and the common electrode CE is formed of a transparent conductive material such as indium tin oxide (ITO) or indium zinc oxide (IZO).

A conductive adhesive layer AD is provided between the first substrate SUB1 and the second substrate SUB2.

In the embodiment, the first substrate SUB1 is an array substrate, and the second substrate SUB2 is the counter-substrate. The base material BA1 and the base material BA2 are formed of insulating materials such as resin and glass. In the embodiment, the base material BA2 is located on a screen side (observation side) and has optical transparency. Since the base material BA1 is located on a side opposite to the screen, the base material BA1 may be untransparent or transparent.

A display function layer DL of the display device DSP is located between the pixel electrodes PE and the counter-electrode CE. A voltage applied between the pixel electrodes PE and the counter-electrode CE is applied to the display function layer DL. In the embodiment, the display device DSP is an electrophoretic display device, and the display function layer DL is an electrophoretic layer. The display function layer DL is formed of a plurality of microcapsules MCP arranged with almost no gaps in the X-Y plane.

The conductive adhesive layer AD of the display device DSP is located between the pixel electrodes PE and the display function layer DL.

The microcapsule MCP is, for example, a spherical body having a particle size of approximately 20 to 70 μm. In the example illustrated, a number of microcapsules MCP are arranged between one pixel electrode PE and the counter-electrode CE, due to the constraints of a scale of the drawing, but approximately one to ten microcapsules MCP are arranged in the pixel PX of a rectangular shape or a polygonal shape in which one side has a length of approximately one hundred to several hundreds of micrometers.

The microcapsule MCP has a dispersant DPR, a plurality of black particles BPL and a plurality of white particles WPL. The black particles BPL and the white particles WPL are often referred to as electrophoretic particles. An outer shell portion (wall film) OWL of the microcapsule MCP is formed of, for example, a transparent resin such as acrylic resin. The dispersant DPR is a liquid that disperses the black particles BPL and the white particles WPL in the microcapsule MCP. The black particle BPL is, for example, a particle (polymer or colloid) formed of black pigment such as aniline black, and is, for example, positively charged. The white particle WPL is, for example, a particle (polymer or colloid) formed of white pigment such as titanium dioxide, and is, for example, negatively charged. Various additives can be added to these pigments as needed. In addition, for example, pigments of red, green, blue, yellow, cyan, magenta, and the like may be used instead of the black particles BPL and the white particles WPL.

When black display is executed in the display function layer DL of the above-described configuration, for example, the first pixel electrodes LE1 is maintained at a higher potential than the counter-electrode UE. In other words, when a potential of the counter-electrode UE is referred to as a reference potential, the first pixel electrodes LE1 is held with positive polarity (+). Positively charged black particles BPL are thereby attracted to the counter-electrode UE. In contrast, negatively charged white particles WPL are attracted to the first pixel electrodes LE1. As a result, black color is visible from the counter-electrode UE side.

In contrast, when a potential of the counter-electrode CE is referred to as a reference potential to execute white display, the second pixel electrodes LE2 are held with positive polarity (−). Negatively charged white particles WPL are thereby attracted to the counter-electrode UE side. In contrast, positively charged black particles BPL are attracted to the second pixel electrode LE2. As a result, white is visible from the counter-electrode UE side.

In the example shown in FIG. 3, the first pixel electrodes LE1 and the second pixel electrodes LE2 are arranged alternately. In other words, each of the plurality of first pixel electrodes LE1 is arranged adjacent to each of the plurality of second pixel electrodes LE2. In other words, a potential of different polarity is applied to the adjacent pixel electrodes PE.

The pixel electrodes PE are covered with the inorganic insulating layer IOI. The material of the inorganic insulating layer IOI is, for example, silicon nitride. In the embodiment, since the inorganic insulating layer IOI is provided, the deterioration in display quality of the display device DSP can be suppressed as compared with a case where the inorganic insulating layer IOI is not provided. The details will be described below.

The first substrate SUB1 is formed by forming the drive element layer DVL and the conductive adhesive layer AD on a large base material and then dividing the base material into individual substrates. At this time, wiring fragments of the drive element layer DVL and parts of the conductive adhesive layer AD remain as foreign matters. If the inorganic insulating layer IOI is not provided and the foreign matters exist between adjacent pixel electrodes PE, that is, between the first pixel electrode LE1 and the second pixel electrode LE2, a short circuit occurs between these electrodes. When a short circuit occurs, these electrodes become fixed potentials, and black particles BPL and white particles WPL do not move. The display failure thereby occurs.

In the display device DSP of the embodiment, the inorganic insulating layer IOI is provided so as to cover the pixel electrodes PE (first pixel electrode LE1 and second pixel electrode LE2). After the inorganic insulating layer IOI is provided on the large base material, the base material is divided into individual substrates. The inorganic insulating layer IOI covering the pixel electrodes PE is provided and, even if foreign matters are generated, the foreign matters do not reach the pixel electrodes PE. The pixel electrodes PE can be thereby prevented from short-circuiting. The degradation in display quality can be thereby suppressed.

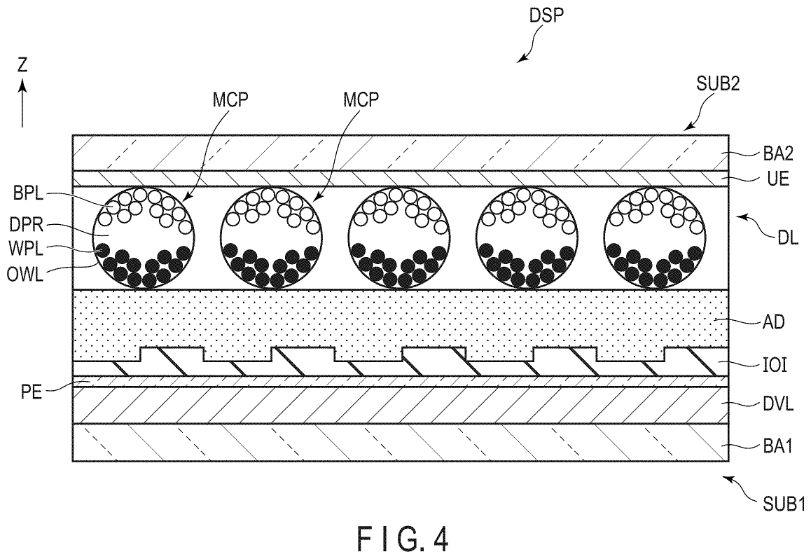

FIG. 4 is a cross-sectional view showing a modified example of the schematic configuration shown in FIG. 3. The shape of the inorganic insulating layer IOI is different from that in FIG. 3, and descriptions on portions common to those in FIG. 3 will be omitted.

The inorganic insulating layer IOI shown in FIG. 4 has a plurality of recesses on the surface which is in contact with the conductive adhesive layer AD. As an example, the inorganic insulating layer IOI has, for example, a thickness of approximately 2 μm and the recesses have a depth of 1 μm. In other words, areas having a large thickness and areas having a small thickness are provided alternately. The recess has a width of 5 μm, and an interval between adjacent recesses is 5 μm.

Entry of the above-described foreign matters is suppressed by forming a plurality of recesses in the inorganic insulating layer IOI on the surface which is in contact with the conductive adhesive layer AD. In addition, the adhesion area between the conductive adhesive layer AD and the inorganic insulating layer IOI can be increased. Thus, the adhesive strength of the conductive adhesive layer AD attached to the first substrate SUB1 can be strengthened.

### Embodiment 2

In view of preventing degradation in display quality, in the embodiment, a display device capable of further preventing the degradation in display quality by improving a configuration of a first substrate SUB1 which is an array substrate will be described.

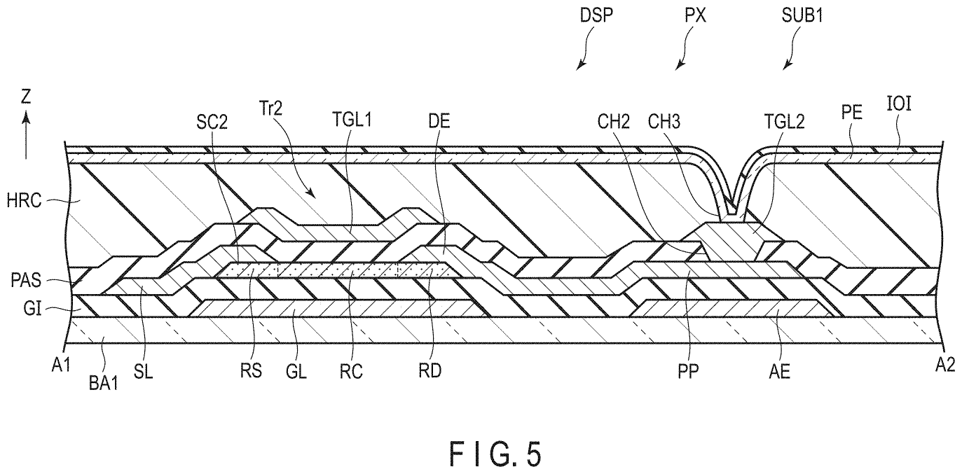

FIG. 5 is a cross-sectional view showing an example of a schematic configuration of the first substrate SUB1. FIG. 5 shows an example of a second transistor Tr2, and a first transistor Tr1 has same configuration.

In the second transistor Tr2, a base material BA1, a scanning line GL (gate electrode), an insulating layer GI, a second semiconductor layer SC2, a signal line SL and a connecting electrode DE, an insulating layer PAS, an electrode TGL1, an insulating layer HRC, and a pixel electrode PE are stacked in this order in the third direction Z. The signal line SL and the connecting electrode DE are formed of the same material. The connecting electrode DE is also referred to as a second electrode.

In addition, as shown in FIG. 5, the base material BA1, a first electrode AE, the insulating layer GI, a third electrode PP, the insulating layer PAS, the insulating layer HRC, and a fourth electrode TGL2 are stacked in this order in the third direction Z. The pixel electrode PE is provided on the insulating layer HRC.

The scanning lines GL and the first electrode

AE are provided on the substrate BA1. The insulating layer GI is provided to cover the scanning lines GL and the third electrode PP. The second semiconductor layer SC2 is provided on the scanning line GL with the insulating layer GI sandwiched therebetween. The second semiconductor layer SC2 is, for example, an oxide semiconductor layer.

In addition, as described below, the first electrode AE is part of a line that constitutes a capacitance line CW, and is opposed to the pixel electrode PE to form a first capacitance C1. The third electrode PP is connected to the pixel electrode PE and the connecting electrode DE, which may also be referred to as a lower pixel electrode and, in this case, the pixel electrodes PE may be referred to as an upper pixel electrode.

The signal line SL is located on an area RS of the second semiconductor layer SC2, is in contact with an area RS2, and is electrically connected to the area RS. The connecting electrode DE is located on an area RD of the second semiconductor layer SC2, is in contact with the area RD, and is electrically connected to the area RD. The area RS and the area RD function as a source area and a drain area, respectively. A channel forming area RC is provided between the area RS and the area RD. The third electrode PP formed integrally with the connecting electrode DE (second electrode) overlaps with the first electrode AE with the insulating layer GI interposed therebetween.

The insulating layer PAS is formed to cover the insulating layer GI, the second semiconductor layer SC2, the signal line SL, the connecting electrode DE, and the third electrode PP. An electrode TGL is provided on the second semiconductor layer SC2 with the insulating layer PAS interposed therebetween. A fourth electrode TGL2 is provided to be in contact with the third electrode PP through a contact hole CH2 provided in the insulating layer PAS.

The insulating layer HRC is provided to cover the insulating layer PAS, the electrode TGL1, and the fourth electrode TGL2. The insulating layer HRC functions as a planarizing layer.

The pixel electrode PE is provided on the insulating layer HRC. The pixel electrode PE is connected to the fourth electrode TGL2 through the contact hole CH3 provided in the insulating layer HRC.

In addition, similarly to FIG. 3, the pixel electrode PE is covered with the inorganic insulating layer IOI.

The scanning line GL and the first electrode AE are formed of the same material in the same layer. The signal line SL, the connecting electrode DE, and the third electrode PP are formed of the same material in the same layer. The electrode TGL1 and the fourth electrode TGL2 are formed of the same material in the same layer.

The electrodes and lines described above are formed of metallic materials such as aluminum (Al), titanium (Ti), silver (Ag), molybdenum (Mo), tungsten (W), and copper (C), chromium (Cr), or alloys combining these metallic materials. In addition, the electrodes and the lies may have a single-layer structure of these metallic materials and alloys or a multilayer structure formed by appropriately stacking the above metallic materials.

For example, the scanning line GL and the first electrode AE may be formed of multilayer films of molybdenum and tungsten. The signal line SL, the connecting electrode DE, and the third electrode PP may be formed of multilayer films of titanium sandwiched by aluminum. The electrode TGL1 and the fourth electrode TGL2 may be formed of multilayer films of aluminum sandwiched by molybdenum.

The material used for the second semiconductor layer SC2 and the first semiconductor layer SC1 in the embodiment is an oxide semiconductor.

Thus, transistors including oxide semiconductors as the semiconductor layer (hereinafter referred to as oxide semiconductor transistors) have extremely low off-leakage current. When oxide semiconductor transistors are used in the pixels of the display devices as switching elements, the charge written to the pixel capacitance can be held for a long time and a desired voltage can be maintained.

The insulating layer GI and the insulating layer PAS are inorganic insulating layers formed of oxides such as silicon oxide (SiO₂) and nitrides such as silicon nitride (SiN). Each of the insulating layer GI and the insulating layer PAS is not limited to a single layer, but may be formed by stacking a plurality of insulating layers. For example, a silicon oxide film may be used for the insulating layer GI and a stacked film of silicon oxide and silicon nitride may be used for the insulating layer PAS.

In addition, the insulating layer HRC may be formed of an organic resin layer, more specifically, acrylic resin or polyimide resin.

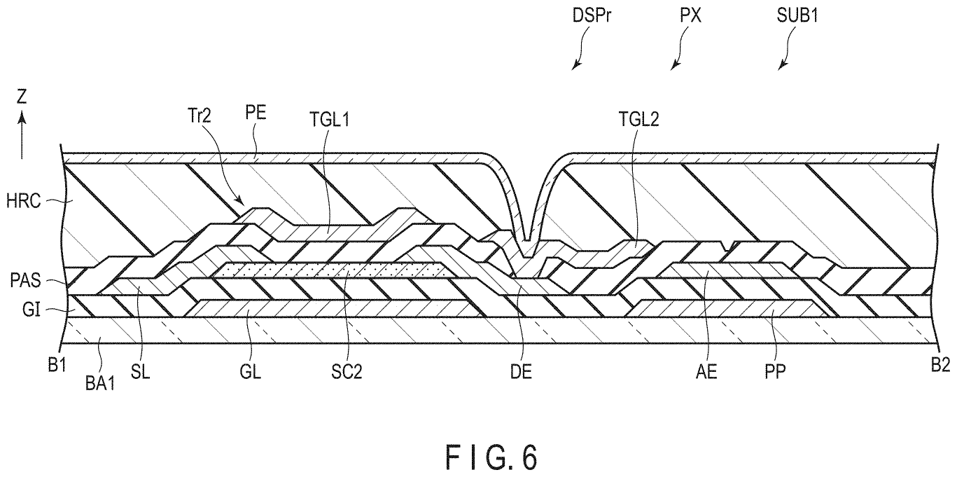

In FIG. 5, no electrodes to which different potentials are applied are arranged between the third electrode PP, which is electrically connected to the pixel electrode PE, and the pixel electrode PE with the insulating layer HRC interposed therebetween. A case where electrodes to which different potentials are applied are arranged with the insulating layer HRC sandwiched in the pixel electrode PE will be described with reference to FIG. 6.

FIG. 6 is a cross-sectional view showing a display device of a comparative example. A display device DSPr shown in FIG. 6 is different from FIG. 5 in that the first electrode AE is provided between the pixel electrode PE and the third electrode PP.

The pixel electrode PE and the first electrode AE are opposed to each other with the insulating layer HRC interposed therebetween. The third electrode PP, which is electrically connected to the pixel electrode PE, is opposed to the first electrode AE with the insulating layer GI interposed therebetween. Details of the connection relationship between the pixel electrode PE and the third electrode PP will be described later.

More specifically, problems that occur when a multilayer film of aluminum sandwiched by titanium (hereinafter referred to as TAT [Titanium/Aluminum/Titanium]) is used for the first electrode AE, ITO is used for the pixel electrode PE, and a multilayer film of aluminum sandwiched by molybdenum (MAM [Molybdenum/Aluminum/Molybdenum]) is used for the fourth electrode TGL2 will be described here. The insulating layer HRC provided between the first electrode AE and the pixel electrode PE is an organic resin layer and contains moisture.

For example, when the second transistor Tr2 is defective, the voltage applied to the pixel electrode PE is not switched and the pixel electrode PE is fixed at a negative potential. As a result, a redox reaction occurs between the negative potential pixel electrode PE and the positive potential first electrode AE. As a result, moisture in the insulating layer HRC ionizes at the pixel electrode PE fixed at negative potential, anions such as O₂⁻ or OH⁻ are generated, the pixel electrode PE may be corroded by the reduction effect and the first electrode AE may be corroded by the oxidation effect.

In addition, anions move through the insulating layer HRC, the anions may react with aluminum and molybdenum in the fourth electrode TGL2, and the fourth electrode TGL2 may be corroded.

These problems related to corrosion may affect the electrodes of the pixels surrounding the pixel including the second transistor Tr2, the range of defects in the pixels may be extended.

In the embodiment, even if the pixel electrode PE is fixed at a negative potential, no potential is directly applied between the pixel electrode PE and the first electrode AE since the first electrode AE is provided between the base material BA1 and the insulating layer GI. For this reason, redox reactions are unlikely to occur. Thus, by adopting the configuration shown in FIG. 5, which greatly weakens the redox reaction between the first electrode AE and the pixel electrode PE, the corrosion of the first electrode AE1, the fourth electrode TGL2, and the pixel electrode PE can also be suppressed.

In addition to the above, the area where the pixel electrode PE is connected with the fourth electrode TGL2 and the third electrode PP is suitably the center portion of the pixel electrode PE in planar view. Anions are generated between the first electrode AE and the pixel electrode PE as described above, and may also be generated between the signal line SL and the pixel electrode PE. The anions generated between the signal line SL and the pixel electrode PE are not affected as much as the anions generated between the pixel electrode PE and the first electrode AE at a fixed potential, since the voltage applied to the signal line SL oscillates between high and low potentials and the area is not so large as the first electrode AE, but, if this area is located at the edge part of the pixel electrode PE, the anions generated by the electric field between the pixel electrode PE and the signal line SL may corrode the fourth electrode TGL2 through the insulating film HRC. The corrosion of the fourth electrode TGL2 can be suppressed by providing a contact hole CH3 connecting the pixel electrode PE and the fourth electrode TGL2 at the center of the pixel electrode PE which is significantly remote from the signal line SL and by separating the fourth electrode TGL2 from the signal line SL at a large distance.

In addition, it is possible to prevent the moisture from the outside of the first substrate SUB1 from penetrating into the lower layer of the pixel electrode PE by covering the pixel electrode PE with an inorganic insulating layer IOI which is resistant to moisture penetration.

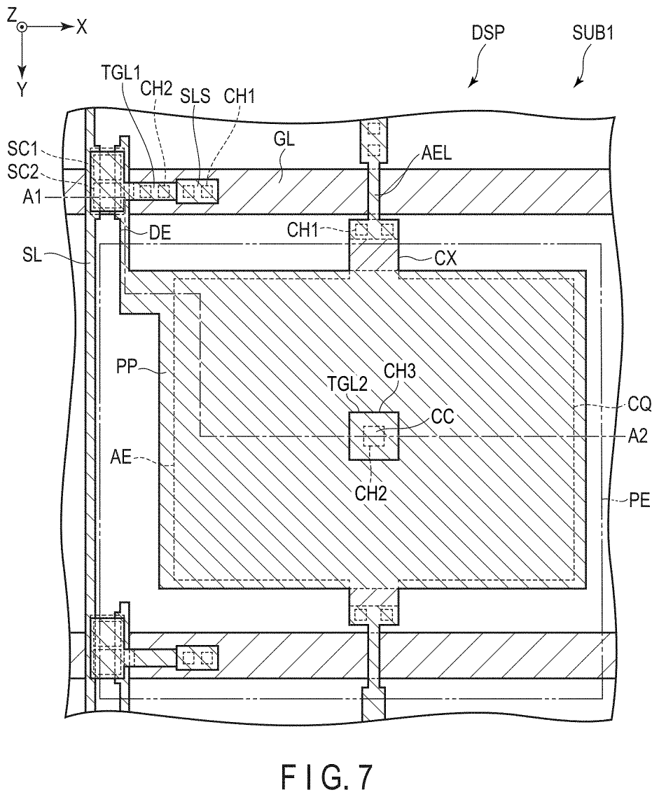

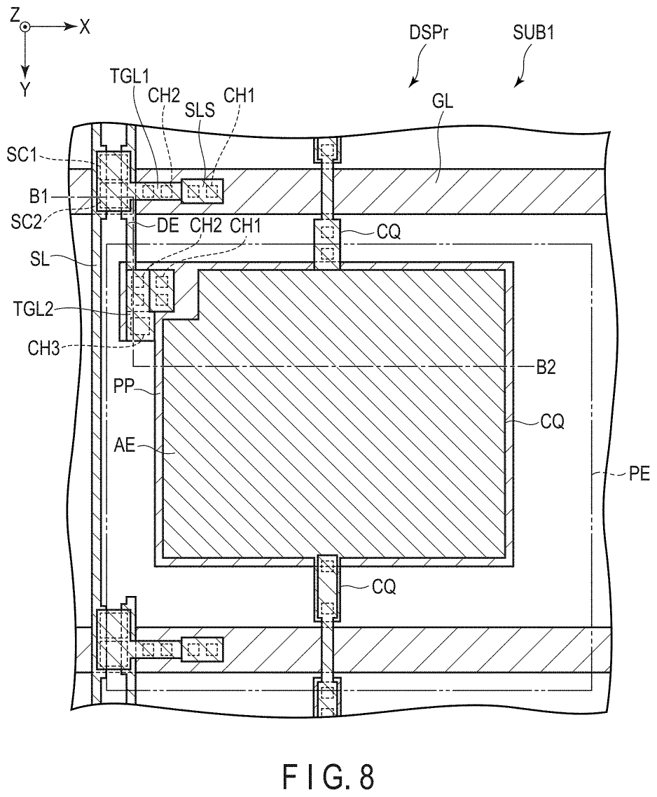

FIG. 7 is an enlarged plan view showing a part of the substrate of the embodiment. In FIG. 7, a cross-sectional view of the display device DSP viewed along line A1-A2 is FIG. 5. FIG. 8 is an enlarged plan view showing a part of the substrate of the comparative example. In FIG. 8, a cross-sectional view of the display device DSPr viewed along line B1-B2 is FIG. 6.

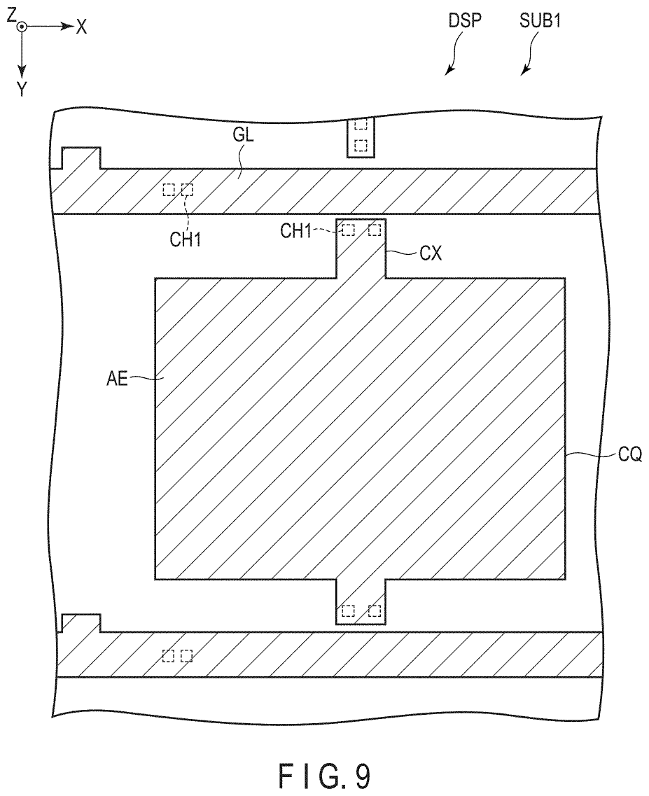

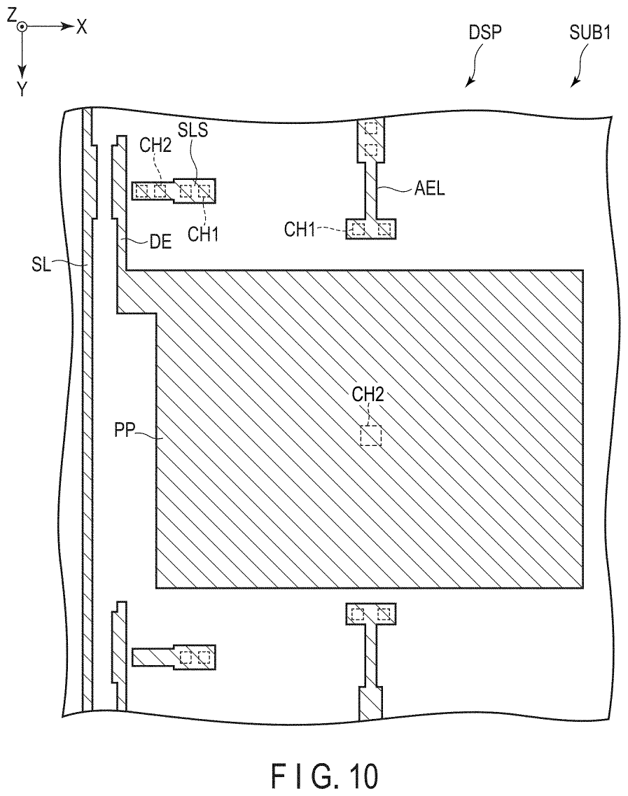

The constituent elements formed of the same material in the same layer as the scanning lines GL, of the display device DSP shown in FIG. 7, are shown in FIG. 9. The constituent elements formed of the same material in the same layer as the signal lines SL, of the display device DSP shown in FIG. 7, are shown in FIG. 10.

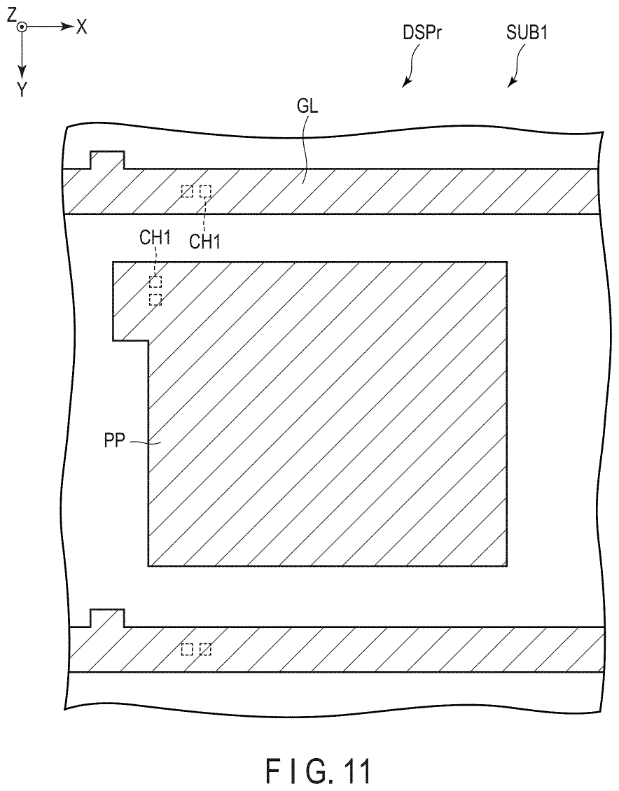

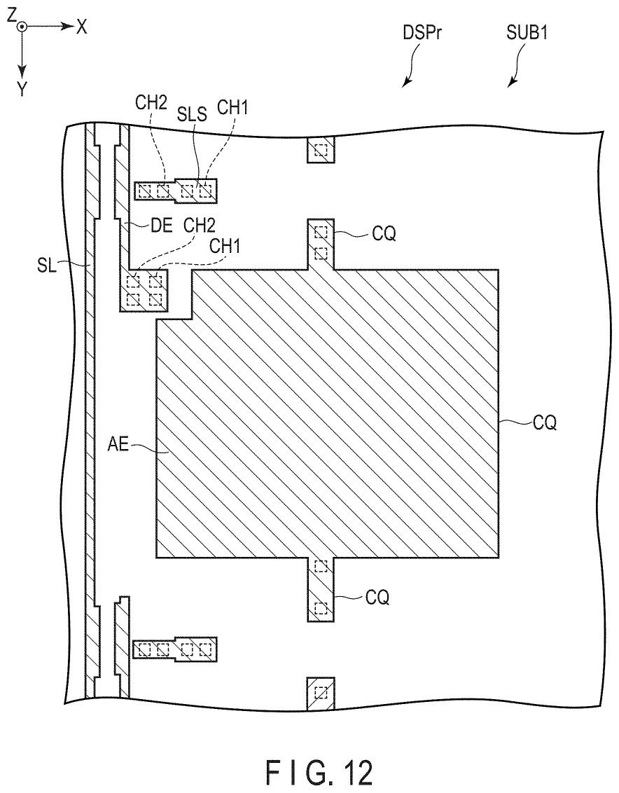

The constituent elements formed of the same material in the same layer as the scanning lines GL, of the display device DSPr shown in FIG. 8, are shown in FIG. 11. The constituent elements formed of the same material in the same layer as the signal lines SL, of the display device DSPr shown in FIG. 8, are shown in FIG. 12.

In the display device DSP shown in FIG. 7, the scanning lines GL extend in the first direction X and are arranged in the second direction Y. The signal lines SL extend in the second direction Y and are arranged in the first direction X. The scanning lines GL and the signal lines SL intersect.

The entire first semiconductor layer SC1 of the first transistor Tr1 and the entire second semiconductor layer SC2 of the second transistor Tr2 overlap with the same scanning line GL.

Overlapping with a part of each of the first semiconductor layer SC1 and the second semiconductor layer SC2, the electrode DE extends along the second direction Y. The third electrode PP, which is integrally formed with the electrode DE, is provided in the area partitioned by the adjacent signal lines SL and the adjacent scanning lines GL.

The first electrode AE is provided to overlap with the third electrode PP. The first electrode AE is formed of the same material in the same layer as the scanning lines GL. The first electrode AE has a rectangular flat portion CQ and a protruding portion CX extending along the second direction Y.

A portion of an electrode AEL, which extends along the second direction Y, overlaps with a portion of the protruding portion CX. The electrode AEL is formed of the same material in the same layer as the signal line SL. The electrode AEL is electrically connected to the protruding portion CX through a contact hole CH1 provided in the insulating layer GI.

The electrode AEL overlaps with the scanning line GL with the insulating layer GI sandwiched therebetween, and is connected to the protruding portion CX of the first electrode AE of the pixel PX adjacent in the second direction Y. As a result, the first electrodes AE of the pixels PX adjacent along the second direction Y are connected to each other. The protruding portion CX and the electrode AEL constitute the capacitance line CW shown in FIG. 2.

The third electrode PP is roughly one size larger than the overlapping flat portion CQ. A center portion CC of the third electrode PP overlaps with the fourth electrode TGL2. The fourth electrode TGL2 is electrically connected to the center portion CC of the third electrode PP through the contact hole CH2 provided in the insulating layer PAS. The pixel electrode PE is connected to the fourth electrode TGL2 through the contact hole CH3 provided in the insulating layer HRC. As a result, the pixel electrodes PE is electrically connected to the third electrode PP.

The pixel electrode PE has a roughly rectangular shape. The pixel electrode PE overlaps with the scanning lines GL of the pixel PX adjacent along the second direction Y.

As shown in FIG. 7, the center portion CC and the fourth electrode TGL2 are provided at roughly equidistant positions from the respective sides of the third electrode PP and the pixel electrode PE. Since the center portion CC and the fourth electrode TGL2 are provided at equidistant positions, the electric field is not concentrated.

The electrode TGL1 is provided to overlap with all parts of the first semiconductor layer SC1, all parts of the second semiconductor layer SC2, a part of the connecting electrode DE, and a part of the scanning line GL. The electrode TGL1 extends along the first direction X. An electrode SLS is provided to overlap with a part of the electrode TGL1 and a part of the scanning line GL. The electrode SLS extends along the first direction X. The electrode SLS is formed of the same material in the same layer as the signal line SL.

The electrode TGL1 is connected to the electrode SLS through the contact hole CH2 provided in insulating layer PAS. The electrode SLS is connected to the scanning line GL through the contact hole CH1 provided in the insulating layer GI. In other words, the electrode TGL1 is electrically connected to the scanning line GL and has the same potential as the scanning line GL. In other words, the electrode TGL1 is an upper gate electrode of the semiconductor layer SC, and the scanning line GL, which overlaps with the semiconductor layer SC, serves as a lower gate electrode of the semiconductor layer SC.

In the display device DSPr of the comparative example, the first electrode AE, which is formed of the same material in the same layer as the signal line SL, is provided on the third electrode PP, which is formed of the same material in the same layer as the scanning line GL. The pixel electrode PE is electrically connected to the third electrode PP.

The connecting electrode DE, which overlaps with a part of the first semiconductor layer SC1 and a part of the second semiconductor layer SC2, extends along the second direction Y. The other part of the connecting electrode DE overlaps with the third electrode PP and the fourth electrode TGL2. The connecting electrode DE is connected to the third electrode PP through a contact hole provided in the insulating layer GI.

The fourth electrode TGL2 is connected to the connecting electrode DE through the contact hole CH2 provided in the insulating layer PAS. The pixel electrode PE is connected to the fourth electrode TGL2 through the contact hole CH3 provided in the insulating layer HRC.

Therefore, the pixel electrode PE is electrically connected to the third electrode PP via the fourth electrode TGL2 and the connecting electrode DE.

In addition, in the comparative example, the area where the connecting electrode DE and the fourth electrode TGL2 are connected and the area where the pixel electrode PE and the fourth electrode TGL2 are connected are provided at positions close to the signal line SL. In such an arrangement, anions may be generated by the electric field generated between the pixel electrode PE and the signal line SL, and the pixel electrode PE and the fourth electrode TGL2 may be thereby corroded.

The positional relationship among the first semiconductor layer SC1, the second semiconductor layer SC2, the connecting electrode DE, the scanning line GL, and the electrode TGL1 shown in FIG. 8 is the same as that in FIG. 7.

The embodiment can suppress corrosion of the pixel electrode PE and the fourth electrode TGL1 by preventing the occurrence of redox reactions between the first electrode AE and the pixel electrode PE. The degradation in display quality of the display device DSP can be thereby suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate including:
a plurality of pixel electrodes that include a plurality of first pixel electrodes and a plurality of second pixels; and
an inorganic insulating layer that covers the plurality of pixel electrodes;
a second substrate including a counter-substrate opposed to the plurality of pixel electrodes; and
an electrophoretic layer arranged between the first substrate and the second substrate.

2. The display device according to claim 1, wherein
the first substrate comprises:
a first base;
a scanning line and a signal line provided on the first base material to cross each other;
a transistor overlapping with the scanning line and the signal line and including a semiconductor layer connected to the signal line;
a first electrode provided in a same layer as the scanning line and being applied with a potential different from the plurality of pixel electrode applied thereto;
a second electrode provided in a same layer as the signal line and overlapping with the semiconductor layer; and
a third electrode formed integrally with the second electrode and having a rectangular shape; and
an organic insulating layer provided between the third electrode and the pixel electrode, wherein
the third electrode and the pixel electrode are electrically connected to each other.

3. The display device according to claim 1, wherein
a material of the inorganic insulating layer is silicon nitride.

4. The display device according to claim 2, comprising:
a conductive adhesion layer between the inorganic insulating layer and the electrophoretic layer, wherein
a plurality of recesses are formed on a surface of the inorganic insulating layer which is in contact with the conductive adhesion layer.

5. The display device according to claim 1, wherein
a voltage of polarity different from the plurality of first pixel electrodes is applied to the plurality of second pixel electrodes.

6. The display device according to claim 2, wherein
the pixel electrode and the third electrode are electrically connected to each other at a center portion of the pixel electrode.

7. The display device according to claim 6, further comprising:
a fourth electrode between the third electrode and the pixel electrode, wherein
the fourth electrode is connected to the third electrode and the pixel electrode at the center portion of the pixel electrode.
